(19) United States
(12) Patent Application Publication
(10) Pub. No.: US 2014/0046727 A1
(43) Pub. Date: Feb. 13, 2014

(54) METHOD, DEVICE, AND SYSTEM FOR GENERATING ONLINE SOCIAL COMMUNITY PROFILES

(71) Applicants: David Stanasolovich, Albuquerque, NM (US); Gyan Prakash, Beaverton, OR (US); Jesse Walker, Hillsboro, OR (US); James Gregg, Phoenix, AZ (US)

(72) Inventors: David Stanasolovich, Albuquerque, NM (US); Gyan Prakash, Beaverton, OR (US); Jesse Walker, Hillsboro, OR (US); James Gregg, Phoenix, AZ (US)

(21) Appl. No.: 13/977,204

(22) PCT Filed: Dec. 29, 2011
(86) PCT No.: PCT/US11/67871

§ 371 Date: Jun. 28, 2013

(51) Int. Cl. G06Q 50/00; G06Q 30/02

(52) U.S. Cl. CPC G06Q 50/01; G06Q 30/0203
USPC 705/7.32

(57) ABSTRACT

A device, method, and system for generating online social community profiles includes collecting behavioral characteristics of community members of an online social community and aggregating the behavioral characteristics to generate a social community profile for the online social community. The social community profile may be used to elicit proposals from vendors, which may be voted on or responded to by the community members of the online social community.

### BACKGROUND

Participation in online social communities is becoming ubiquitous for many people in many different facets of their life including, for example, business, person-to-person networking, philanthropy, advocacy of various types, and the like. The online social communities may be formed for a variety of reasons such as to connect people with common interests, hobbies, educational needs, travelling, buying/selling, or likes; to pool community resources or online presence; to share information or data; and/or to facilitate other objectives or goals of like-minded individuals. Often such online social communities operate, or otherwise use, an online location, such as an online forum, blog, or website, which is used as a common online gathering, communicating, and information distribution location.

Many online businesses and/or research companies attempt to monitor and determine the online behavior of individuals. Such monitored online behavior is typically associated with the individual's purchasing likes/dislikes and habits. Many times, such individual online behavior analysis is based on the historic commercial activity of the particular individual. Analysis of the historic activity of the individual is typically limited to the interaction of the individual with the particular company performing such analysis, and cannot be generalized to other companies, products, or larger collection of individuals, such as an online social community.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a system for generating online social community profiles;

FIG. 2 is a simplified block diagram of at least one embodiment a software environment of an online community profile server of the system of FIG. 1;

FIG. 3 is a simplified flow diagram of at least one embodiment of a method for generating a selection of community behavior characteristics to track that may be executed by the online community profile server of FIG. 2;

FIG. 4 is a simplified flow diagram of at least one embodiment of a method for generating a social community profile that may be executed by the online community profile server of FIG. 2;

FIG. 5 is a simplified drawing of at least one embodiment of a community member profile questionnaire that may be used in the method of FIG. 4; and

FIG. 6 is a simplified flow diagram of at least one embodiment of a method for managing proposals from vendors based on the social community profile.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects or links between components and/or one or more point-to-point interconnects between components. Embodiments of the invention may also be implemented as instructions carried by or stored on a transitory or non-transitory machine-readable medium, which may be read and executed by one or more processors. A machine-readable medium may be embodied as any device, mechanism, or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings of schematic elements, such as those representing devices, modules, instruction blocks and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

In general, schematic elements used to represent instruction blocks may be implemented using any suitable form of machine-readable instruction, such as software or firmware applications, programs, functions, modules, routines, processes, procedures, plug-ins, applets, widgets, code fragments and or others, and that each such instruction may be implemented using any suitable programming language, library, application programming interface (API), and/or other software development tools. For example, some embodiments may be implemented using Java, C++, and/or other programming languages. Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. In addition, for case of illustration, a single connecting element may be used to represent multiple connections, relationships or associations between elements. For example, where a connecting element represents a communication of signals, data or instructions, it should be understood by those skilled in the art that such element may represent one or multiple signal paths (e.g. a bus), as may be needed, to effect the communication.

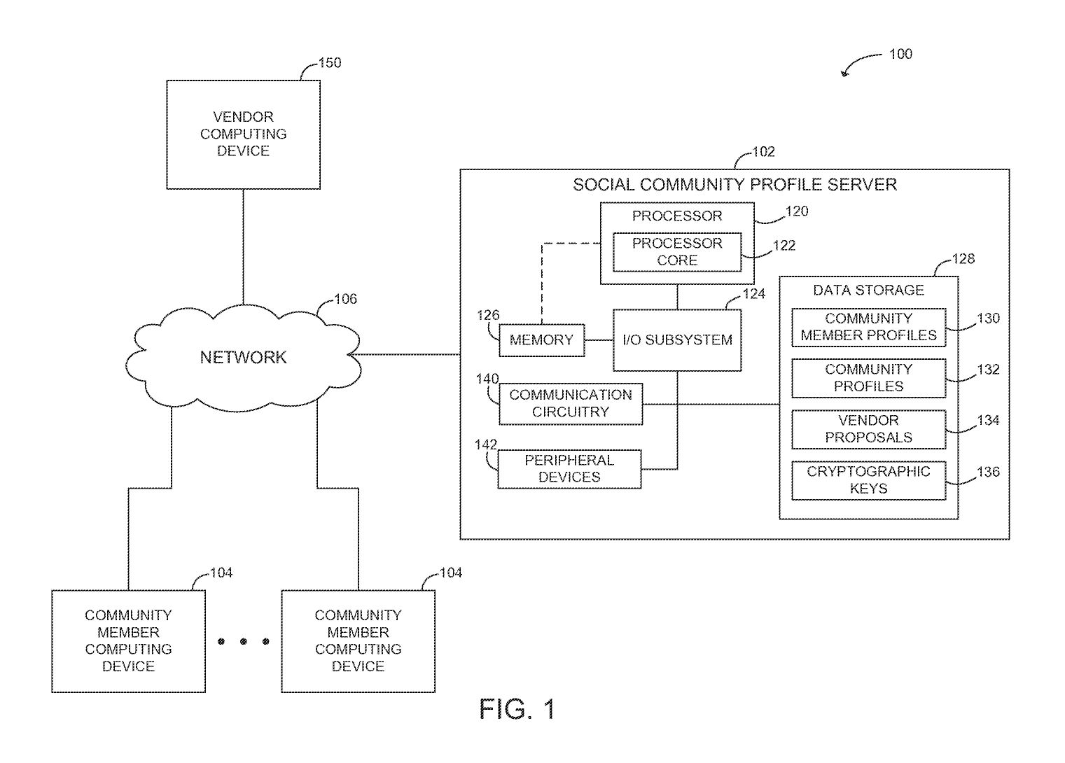

Referring now to FIG. 1, a system 100 for generating online social community profiles includes a social community profile server 102 and a plurality of community member computing devices 104, which communicate with the social community profile server 102 over a network 106. In use, the social community profile server 102 generates a social community profile for an online social community by collecting and aggregating behavioral characteristics of individual community members of the online social community. For example, in some embodiments as discussed in more detail below, the social community profile server 102 may present an online questionnaire to each community member and determine the individual community member's behavioral characteristics based on the community member's responses to the online questionnaire. Additionally or alternatively, the social community profile server 102 may monitor each community member's online activities or behavior to determine or supplement the individual community member's behavioral characteristics. Such additional monitoring, as well as participation in the collection of the individual behavioral characteristics, may require an “opt-in” by each community member as discussed below.

The social community profile provides a summary of the aggregated or averaged behavioral characteristics of the community members of the online social community. That is, the social community profile provides a summary of the identity and/or behavioral characteristics, tendencies, and preferences of the online social community as a whole. The particular behavioral characteristics used to generate the social community profile may include any type of data indicative of a characteristic of a community member. For example, the behavioral characteristics may include data indicative of an identity of the individual community member such as the community member's gender, age, income, nationality, political affiliation, or the like. Additionally or alternatively, the behavioral characteristics may include data indicative of an economic behavior, preference, or habit of the community member such as the community member's recent purchasing history, preference for a particular brand or model of a product, likelihood to purchase a similar product in the future, preference for particular features, current ownership of particular products, and/or other data indicative of the community member's economic behavior or tendencies. Of course, the behavioral characteristics may include any additional or other data indicative of a characteristic of the community members and of interest to third-parties, such as the vendors discussed below, in other embodiments.

The social community profile server 102 may allow access to the social community profile by the online social community itself, as well as third-party entities. For example, in some embodiments, the social community profile server 102 may present the social community profile, or a sub-profile based on the main social community profile, at an online location such as a social network website, blog, or forum frequented or established by the online social community. In one particular embodiment, the social community profile is presented to, or otherwise made available to, a vendor for review and consideration. For example, the vendor may operate a vendor computing device 150 to access the social community profile directly from the social community profile server 102 via the network 106 and/or from the online location (e.g., website, forum, blog, etc.) at which the social community profile was posted or otherwise presented.

A vendor may be embodied as any third-party entity that is separate from the online social community of interest. For example, in some embodiments, the vendor may be embodied as a business, a charitable organization, another online social community, a political organization, a marketing research company, or any other third-party entity interested in the social community profile of the online social community. The vendor may access the social community profile and present a proposal to the online social community based, at least in part, on the social community profile. Such proposals may be embodied as any type of proposal, offer, advertisement, questionnaire, marketing poll, or other request or offer for consideration by the online social community. The actual proposal may be embodied as a static, online proposal (e.g., a coupon) or as an active proposal wherein the vendor may participate in an online meeting or discussion with the online social community as discussed in more detail below.

The social community profile server 102 may be embodied as any type of data server capable of performing the functions described herein. In the illustrative embodiment of FIG. 1, the social community profile server 102 includes a processor 120, an input/output (I/O) subsystem 124, a memory 126, a data storage 128, and communication circuitry 140. In some embodiments, several of the foregoing components may be incorporated on a motherboard of the social community profile server 102, while other components may be communicatively coupled to the motherboard via, for example, a peripheral port. Furthermore, it should be appreciated that the social community profile server 102 may include other components, sub-components, and devices commonly found in a data sever, which are not illustrated in FIG. 1 for clarity of the description.

The processor 120 of the social community profile server 102 may be embodied as any type of processor capable of executing software/firmware, such as a microprocessor, digital signal processor, microcontroller, or the like. The processor 120 is illustratively embodied as a single core processor having a processor core 122. However, in other embodiments, the processor 120 may be embodied as a multi-core processor having multiple processor cores 122. Additionally, the social community profile server 102 may include additional processors 120 having one or more processor cores 122.

The I/O subsystem 124 of the social community profile server 102 may be embodied as circuitry and/or components to facilitate input/output operations with the processor 120 and/or other components of the social community profile server 102. In some embodiments, the I/O subsystem 124 may be embodied as a memory controller hub (MCH or “northbridge”), an input/output controller hub (ICH or “southbridge”), and a firmware device. In such embodiments, the firmware device of the I/O subsystem 124 may be embodied as a memory device for storing Basic Input/Output System (BIOS) data and/or instructions and/or other information (e.g. a BIOS driver used during booting of the social community profile server 102). However, in other embodiments, I/O subsystems having other configurations may be used. For example, in some embodiments, the I/O subsystem 124 may be embodied as a platform controller hub (PCH). In such embodiments, the memory controller hub (MCH) may be incorporated in or otherwise associated with the processor 120, and the processor 120 may communicate directly with the memory 126 (as shown by the hashed line in FIG. 1). Additionally, in other embodiments, the I/O subsystem 124 may form a portion of a system-on-a-chip (SoC) and be incorporated, along with the processor 120 and other components of the social community profile server 102, on a single integrated circuit chip.

The processor 120 is communicatively coupled to the I/O subsystem 124 via a number of signal paths. These signal paths (and other signal paths illustrated in FIG. 1) may be embodied as any type of signal paths capable of facilitating communication between the components of the social community profile server 102. For example, the signal paths may be embodied as any number of point-to-point links, wires, cables, light guides, printed circuit board traces, via, bus, intervening devices, and/or the like.

The memory 126 of the social community profile server 102 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 126 is communicatively coupled to the I/O subsystem 124 via a number of signal paths. Although only a single memory device 126 is illustrated in FIG. 1, the social community profile server 102 may include additional memory devices in other embodiments. Various data and software may be stored in the memory device 126. For example, one or more operating systems, applications, programs, libraries, and drivers that make up the software stack executed by the processor 120 may reside in memory 126 during execution.

The data storage 128 may be embodied as any type of device or devices configured for the short-term or long-term storage of data such as, for example, memory devices and circuits, memory cards, hard disk drives, solid-state drives, or other data storage devices. In the illustrative embodiment, the individual community member profiles 130 (i.e., the collected behavioral characteristics of each community member) are stored in the data storage 128. To ensure the privacy of each community member of the online social community, the individual community member profiles 130 may be stored in an encrypted state using cryptographic keys 136 of the social community profile server 102. Additionally, as discussed in more detail below, the individual community member profiles 130 are never displayed or accessible to the public (although each community member may be able to access his/her individual community member profile 130 in some embodiments). Rather, the social community profile, and sub-profiles generated therefrom, is displayed to the public and interested vendors. Such social community profiles 132, and associated sub-profiles, are also stored in the data storage 128. Additionally, any proposals 134 received from the vendors may be stored in the data storage 128. As discussed in more detail below, the proposals received from the vendors may be embodied as any type of proposal, offer, advertisement, questionnaire, marketing poll, or other request or offer for consideration by the online social community.

The communication circuitry 140 of the social community profile server 102 may be embodied as any number of devices and circuitry for enabling communications between the social community profile server 102 and other devices of the system 100, such as the community member computing devices 104, over the network 106. The network 106 may be embodied as any number of various wired and/or wireless communication networks. For example, the network 106 may be embodied as or otherwise include a local area network (LAN), a wide area network (WAN), or a publicly-accessible, global network such as the Internet. Additionally, the network 106 may include any number of additional devices to facilitate communication between the social community profile server 102 and the other devices of the system 100 (e.g., the community member computing devices 104 and the vendor computing device 150). The social community profile server 102 may use any suitable communication protocol to communicate with the other devices of the system 100 over the network 106 depending on, for example, the particular type of network(s) 106.

In some embodiments, the social community profile server 102 may also include one or more additional peripheral devices 142. Such peripheral devices 142 may include any number of additional input/output devices, interface devices, and/or other peripheral devices. For example, the peripheral devices 142 may include a display, a keyboard, mouse, or other input/output peripheral device. The peripheral devices 142 are communicatively coupled to the I/O subsystem 124 via a number of signal paths thereby allowing the I/O subsystem 124 and/or processor 120 to receive inputs from and send outputs to the peripheral devices 142.

As discussed above, the system 100 includes a plurality of community member computing devices 104. Such computing devices 104 may be embodied as any type of computing devices capable of communicating with remote devices, such as the social community profile server 102, a social network server, or other device, over the network 106. For example, the community member computing devices 104 may be embodied as any type of a smart phone, mobile internet device, tablet computer, laptop computer, desktop computer, personal digital assistant, or other mobile or substantially stationary computer or computing device. As such, the community member computing devices 104 may include various hardware and software components (e.g., a processor and memory) typically found in a computing device capable of communicating with remote devices over the network 106, which have not been illustrated in FIG. 1 for clarity of the description. It should be appreciated that although only two community member computing devices 104 are illustrated in FIG. 1 for clarity, the system 100 may include additional community member computing devices 104 in other embodiments.

The system 100 may also include one or more vendor computing devices 150 as discussed above. Similar to the community member computing devices 104, the vendor computing devices 150 may be embodied as any type of computing device capable of communicating with the social community profile server 102 over the network 106. For example, the vendor computing device 150 may be embodied as any type of mobile or desktop computer, laptop computer, tablet computer, smart phone, mobile internet device, personal digital assistant, or other mobile or substantially stationary computer or computing device. As such, the vendor computing device 150 may include various hardware and software components (e.g., a processor and memory) typically found in a computing device capable of communicating with remote devices over the network 106, which have not been illustrated in FIG. 1 for clarity of the description. Of course, it should be appreciated that although only one vendor computing device 150 has been illustrated in FIG. 1 for clarity, the system 100 may include additional vendor computing devices 150 in other embodiments. Additionally, in some embodiments, the vendor computing device 150 may be the same as, or otherwise incorporated in, the social community profile server 102.

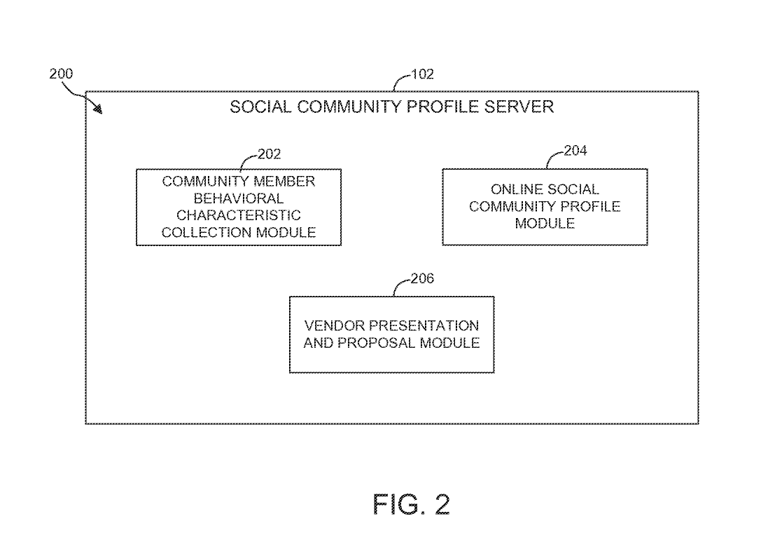

Referring now to FIG. 2, in use, the social community profile server 102 establishes a software/hardware environment 200 for generating, maintaining, and promoting the social community profile of the online social community. The illustrative environment 200 includes a community member behavioral characteristic collection module 202, an online social community profile module 204, and a vendor presentation and proposal module 206. Of course, the software/hardware environment 200 may include additional or fewer modules in other embodiments. Each of the modules 202, 204, 206 may be embodied as, or otherwise include, stand-alone software applications, software/firmware modules, and/or associated hardware.

The community member behavioral characteristic collection module 202 collects and maintains the behavior characteristics of individual community members and stores the behavior characteristics as individual community member profiles 130 in the data storage 128. As discussed above, to ensure the privacy of the community members, each individual community member profile 130 may be stored in the data storage 128 in an encrypted state. The community member behavioral characteristic collection module 202 may collect the behavior characteristics of the individual community members using any suitable methodology. In one particular embodiment, for example, the community member behavioral characteristic collection module 202 generates a questionnaire having a plurality of behavior characteristic questions and presents the questionnaire to the individual community members. For example, upon joining the online social community (e.g., obtaining a user account to a social networking site, forum, blog, or other website), a new community member may be presented with the questionnaire in order to collect the behavior characteristics of the new community member. Additionally or alternatively, new questionnaires may be periodically or occasionally presented to the community members of the online social community to update the social community profile. Further, in some embodiments, the community member behavioral characteristic collection module 202 may be configured to monitor the online behavior (e.g., online purchasing behavior) of the community members to supplement, or otherwise generate, the behavior characteristics. In this way, the community member behavioral characteristic collection module 202 collects the behavior characteristics of community members of the online social community.

The online social community profile module 204 generates the online social community profile based on or as a function of the behavior characteristics of the individual community members collected by the community member behavioral characteristic collection module 202. To do so, in one embodiment, the online social community profile module 204 may aggregate or average the various behavioral characteristics of the individual community members to generate the online social community profile, which is embodied as the collection of aggregated/averaged behavioral characteristics. Of course, the online social community profile module 204 may use other methods or algorithms to aggregate the behavior characteristics to generate the online social community profile in other embodiments. Additionally, in some embodiments, the online social community profile module 204 may generate, or otherwise derive, one or more sub-profiles as a function of the online social community profile. For example, each sub-profile may be a collection of particular aggregated behavior characteristics that are selected based on one or more criteria such as the type of vendor requesting the profile.

The vendor presentation and proposal module 206 presents, or otherwise allows access to, the generated online social community profile at one or more online locations. For example, in some embodiments, the vendor presentation and proposal module 206 uploads, posts, or otherwise presents the online social community profile at a website (e.g., a social network website, a forum, blog, or other website or location) established or used by the online social community to thereby allow interested third-parties, such as vendors, to review the online social community profile. Additionally or alternatively, the vendor presentation and proposal module 206 may receive requests from vendors to access the online social community profile (or a particular sub-profile thereof) and respond by presenting (e.g., e-mailing) or allowing access to the online social community profile to the vendor. Any proposal offered by the vendor in response to the online social community profile is received by the vendor presentation and proposal module 206. The module 206 processes the proposal by, for example, presenting the proposal to the online social community for voting thereon, establishing an online meeting between the vendor and the online social community, and/or performing other action in response to proposal. The vendor presentation and proposal module 206 may also present the online social community's response to the proposal to the vendor and/or the online social community itself (e.g., by posting the voting tally to the online social community's website or other online location).

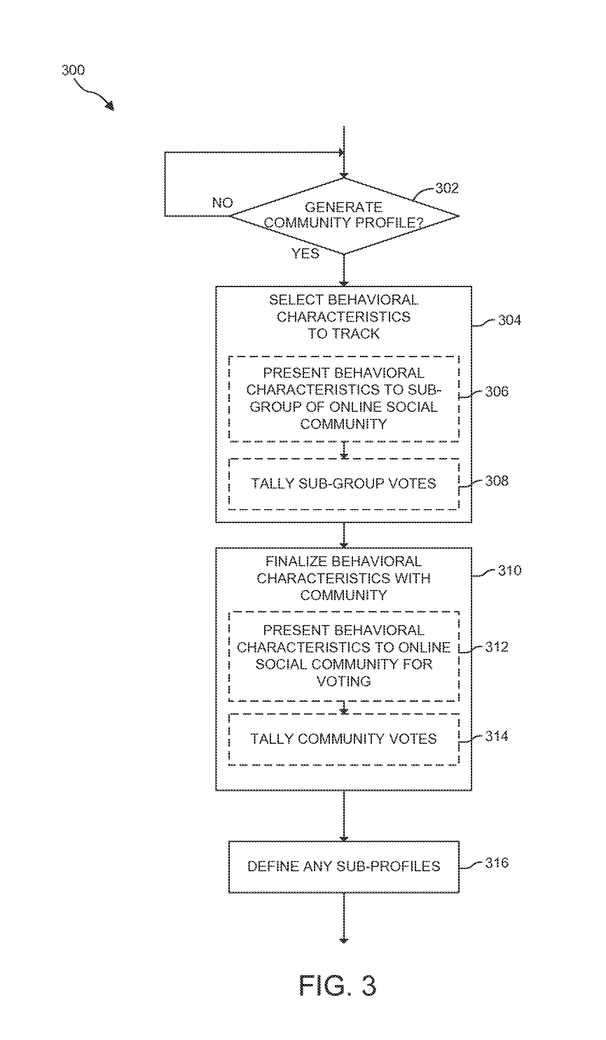

Referring now to FIG. 3, as discussed above, the community member behavioral characteristic collection module 202 may generate a questionnaire to collect the behavioral characteristics of the individual community members. To do so, the social community profile server 102 may execute a method 300 for generating a selection of community member behavioral characteristics to track. The method 300 begins with block 302 in which the online social community profile server 102 determines whether to generate or update an online social community profile. As discussed above, the online social community profile may be generated and/or updated by tracking or collecting behavioral characteristics of the community members of the online social community. If not, the method 300 loops back to block 302.

However, if the online social community profile server 102 determines that a new or updated online social community profile is to be generated, the method 300 advances to block 304 in which the individual behavioral characteristics to be tracked are selected. As discussed above, the behavioral characteristics selected to be tracked may include any type of data indicative of a characteristic of the community members including, for example, data indicative of an identity of the community members, data indicative of an economic behavior, preference, or habit of the community members, and/or any additional or other data indicative of a characteristic of the community members and of interest.

In the illustrative embodiment, the behavioral characteristics to be tracked are selected by presenting the available behavioral characteristics to a sub-group of the online social community selected to determine the behavioral characteristics to track in block 306. The sub-group may be, for example, an elected committee or group of community members chosen for such purpose. The available behavioral characteristics may be behavioral characteristics that were previously identified by the sub-group, pre-generated by the social community profile server 102, or otherwise identified by sub-group, the online social community as a whole, a vendor, or other entity or source. After the available behavioral characteristics are identified and presented to the sub-group in block 306, the sub-group of the online social community votes on those behavioral characteristics to track to generate the online social community profile. Any type of voting methodology may be used to determine the selected behavioral characteristics, for example, in one embodiment, an online voting methodology is used to allow the sub-group community members to vote on each behavioral characteristic.

In block 310, the selected behavioral characteristics of the community members to be tracked are finalized with the online social community. To do so, in one embodiment, the behavioral characteristics selected by the sub-group in block 306 are presented to the online social community, as a whole, for voting. For example, the behavioral characteristics may be presented to, or otherwise accessible by, each community member at a secure online location to allow each community member to vote on those behavioral characteristics that should be tracked. In block 314, the votes from the community members are tallied, and the behavioral characteristics to be tracked are finalized based on the community members' votes. Again, any suitable voting methodology may be used including, for example, a simple majority, supermajority, or other level of acceptance by the online social community usable to determine whether a particular behavioral characteristic should be included.

In the illustrative embodiment, after the behavioral characteristics to be tracked are finalized with the online social community, an online questionnaire is generated as a function of the selected behavioral characteristics. That is, the behavioral characteristics of the community members are collected by presenting each community member with an online questionnaire. The responses of each community member may then be collected and aggregated to generate the online social community profile as discussed below. Of course, other methodologies of collecting the selected behavioral characteristics may be used in other embodiments.

In block 316, any additional sub-profiles that will be generated in addition to the online social community profile are defined. As discussed above, the sub-profiles may be embodied as collections of particular behavioral characteristics less than, or otherwise different from, the main online social community profile. The sub-profiles may be “views” or “snap-shots” of the main online social community profile that are defined for a particular type of vendor or purpose. For example, some vendors may be interested in particular behavioral characteristics different from other vendors. By providing multiple sub-profiles, the online social community can tailor the online social community profile for particular vendors.

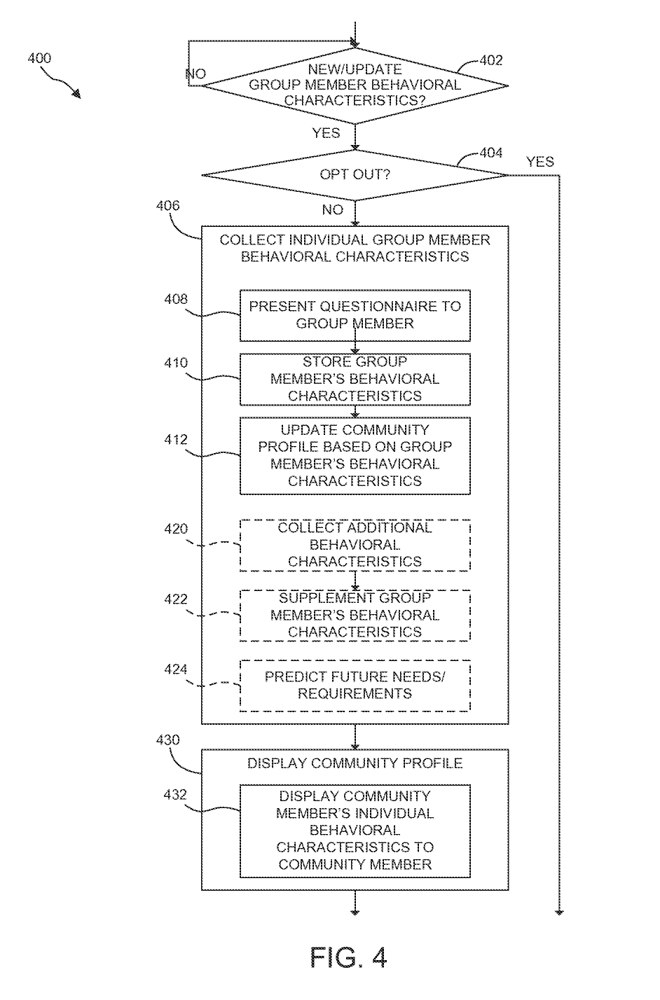

Referring now to FIG. 4, after the particular behavioral characteristics to be tracked are determined, the online social community profile server 102 may execute a method 400 to collect the behavioral characteristics of the community members of the online social community. The method 400 begins with block 402 in which the online social community profile server 102 determines whether to collect or update behavioral characteristics for a particular community member. Such determination may be made based on, for example, whether such behavioral characteristic have already been collected (e.g., whether the particular community member has already submitted an online questionnaire), whether a certain amount of time has passed since collecting the behavioral characteristics (i.e., the behavioral characteristics may be periodically updated), whether the particular community member has selected to submit behavioral characteristics, and/or any other criteria. If not, the method 400 loops back to block 402.

However, if the online social community profile server 102 determines that behavioral characteristics are to be collected or updated for the particular community member, the method 400 advances to block 404 in which the community member may opt-out of the collection of the behavioral characteristics. That is, in order to protect the privacy of community members, each community member may be presented with the option of not answering or submitting any information related to the tracked behavioral characteristics. If a community member decides to opt-out of such collection process (e.g., by selecting an “opt-out” option), the method 400 exits.

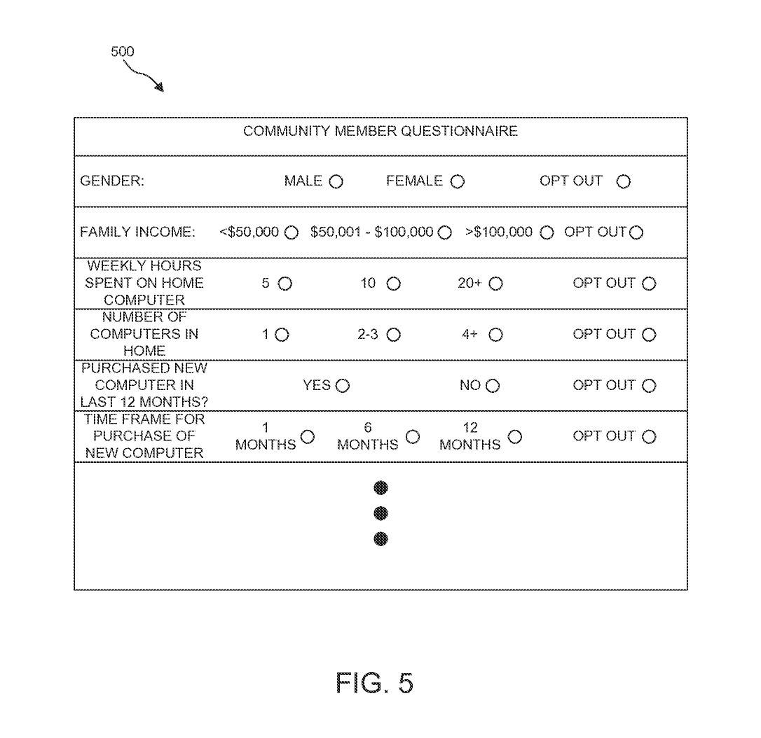

If, however, the community member does not opt-out of the collection process, the method 400 advances to block 406 in which the behavioral characteristics of the individual community member is collected. To do so, in the illustrative embodiment, community member is presented with an online questionnaire in block 408. As discussed above, the online questionnaire is generated as a function of the behavioral characteristics selected to be tracked by the online social community. As such, the online questionnaire may include behavioral characteristics questions or requests that are to be answered by the community members in order to collect the behavioral characteristics of the online social community as a whole. One illustrative embodiment of an online questionnaire 500 that may be presented to the community members is shown in FIG. 5. The illustrative questionnaire 500 includes a plurality of behavioral characteristic questions to be answered by the community member. To protect the privacy of the community members, each question illustratively includes an opt-out selection that may be selected by the community member to avoid answering the associated behavioral characteristics question. Each question may include multiple, selectable answers as shown in the questionnaire of FIG. 5 or may include a data entry widget in which the community member may type or submit the answer. As discussed above, the questionnaire 500 may include any number of questions to track the selected behavioral characteristics.

Referring back to FIG. 4, the community member's answers to the online questionnaire are received by the online social community profile server 102 in block 410. The community member's answers form the behavioral characteristics for that particular community member and may be stored by the online social community profile server 102 in the data storage 128. As discussed above, in order to protect the privacy of each community member, the community member behavioral characteristics or profiles 130 may be stored in the data storage 128 in an encrypted state using the cryptographic keys 136 of the online social community profile server 102.

In block 412, the online social community profile is updated (or generated) as a function of the collected behavioral characteristics of the community member(s). To do so, in the illustrative embodiment, the online social community profile server 102 aggregates the behavioral characteristics of each community member. That is, the online social community profile server 102 aggregates the answers to the online questionnaire provided by each community member and generates the online social community profile based thereon. As such, in the illustrative embodiment, the online social community profile is embodied as a collection of aggregated behavior characteristics.

The online social community profile server 102 may use any suitable methodology to aggregate the collected behavioral characteristics of the community members to generate the online social community profile. For example, in one embodiment, the online social community profile server 102 averages the behavioral characteristics collected for each community member to generate an averaged behavioral characteristic for the online community. Of course, the online social community profile server 102 may use other methodologies (e.g., a weighted average) in other embodiments to generate the online social community profile.

In some embodiments, the online social community profile server 102 may be configured to collect additional behavioral characteristics of each community member in block 420. For example, the online social community profile server 102 may monitor, or otherwise track, the online behavior of each community member. Such online behavior may include, for example, the online purchasing history or behavior of the community member, the websites visited by the community member, and/or other data indicative of the online behavior of the community member. Of course, such tracking of the community member's online behavior may be optional (e.g., an opt-in policy may be used) and may be limited to particular, pre-defined online behaviors, websites, and/or the like. If the online social community profile server 102 does collect the additional behavior characteristics, the server 102 may supplement the behavioral characteristics collected using other methodologies, such as the online questionnaire, in block 422.

In some embodiments, the online social community profile server 102 may generate or determine additional behavioral characteristics for each community member by predicting a future need or requirement for each community member in block 424. To do so, the online social community profile server 102 may analyze the other behavioral characteristics collected for the individual community member and compare those behavioral characteristics to known or predetermined requirements, which may be stored in a data storage 128. For example, based on the collected behavioral characteristics, the online social community profile server 102 may determine that the particular user is likely to travel to another country within the near future (e.g., based on information provided by the community member in the questionnaire or collected based on the monitored online behavior of the community member). If so, the server 102 may determine certain products or services that the community is likely to need while traveling (e.g., a power converter, luggage, a hotel room and service, shuttling service, etc.). The predicted product and/or service needs of the community member may be stored as additional behavioral characteristics, which may be subsequently presented to vendors for consideration in generating a proposal to the online social community (or directly to the individual community member).

Further, in some embodiments, the online social community profile server 102 may be configured to compare the collected behavior characteristics of each community member (e.g., the community member's interests, hobbies, educational needs, travelling, buying/selling history, like/dislikes, online behavior patter, etc.) to known criminal behavior patterns such as known terrorist online behavior. Based on such comparison, the online social community profile server 102 may determine whether the community member's behavior characteristics indicate a likelihood of such criminal behavior or participation and flag the community member for further tracking (in compliance with any applicable local laws and privacy policies). Additionally, the online social community profile server 102 may alert law enforcement authorities of such community members for further investigation.

In block 430, the generated online social community profile is displayed to the online social community. As discussed above, the online social community profile may be displayed to the online social community at an online location (e.g., social network website, forum, blog, or other website) established or used by the online social community. In some embodiments, the full or main online social community profile is displayed to the public at the online location (i.e., the online social community profile is available for viewing by the general public). However, in other embodiments, the main online social community profile may be protected and shown only to authorized community members. For example, each community member may be required to enter a password in order to view the full online social community profile.

Additionally, in some embodiments, the online social community profile server 102 may be configured to display the individual community member profile 130 (i.e., the behavioral characteristics determined for a particular community member) to the associated community member in block 432. Again, to protect the privacy of the community members, the individual community member profiles 130 are displayed only to the individual community members and not to the online social community as a whole. For example, each community member may be able to view his/her respective community member profile (i.e., his/her behavioral characteristics) by entering a password or other security measure.

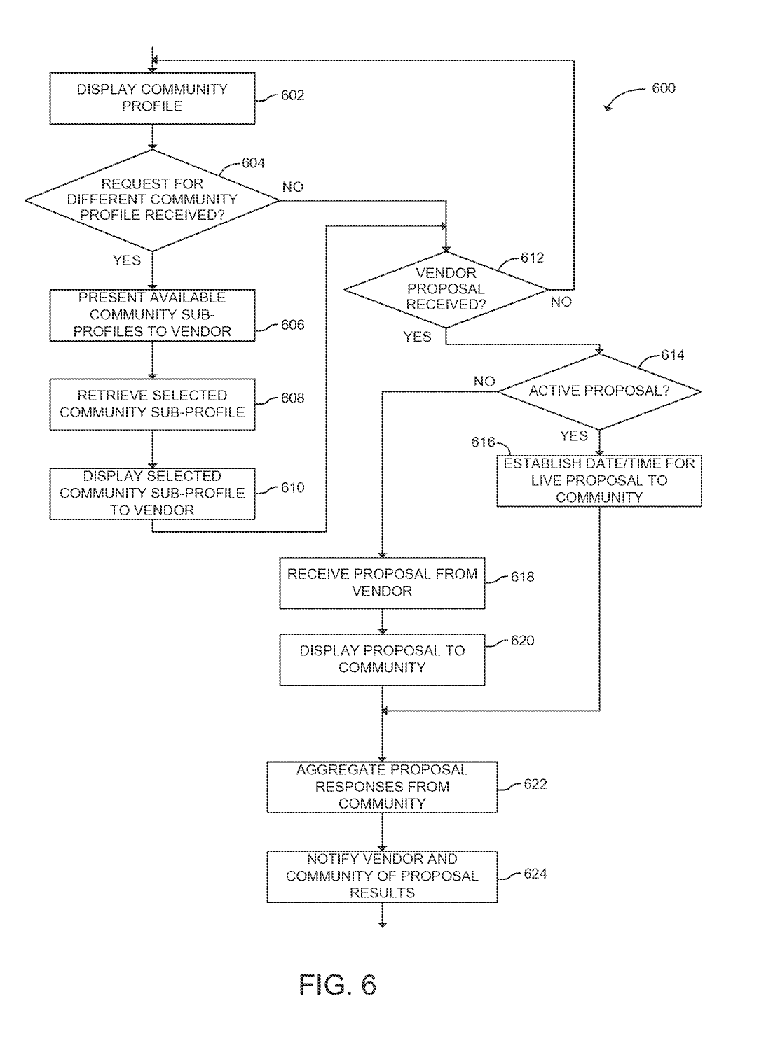

Referring now to FIG. 6, as discussed above, the online social community profile server 102 may allow access to the online social community profile by third-party vendors for their consideration and receive various proposals from such vendors in response to the online social community profile. To do so, the online social community profile server 102 may execute a method 600 for managing proposals received from vendors. The method 600 begins with block 602 in which the online social community profile server 102 displays the generated online social community profile to the vendor. As discussed above, in some embodiments, the online social community profile may be displayed to the general public at an online location (e.g., a website established or used by the online social community). Alternatively, the online social community profile server 102 may receive a request for the online social community profile from the vendor computing device 150 and directly transmit the online social community profile to the vendor computing device 150 in response thereto in block 602.

In block 604, the online social community profile server 102 determines whether the vendor has requested a different community profile. As discussed above, the online social community profile server 102 may maintain various sub-profiles of the main online social community profiles for display to particular vendors, for example. If the vendor has requested a different online social community profile in block 604, the method 600 advances to block 606 in which the online social community profile server 102 presents the vendor with the available online social community sub-profiles. The vendor may subsequently select one or more of the available online social community sub-profiles for viewing in block 608, which is displayed to the vendor in block 610. Alternatively, in some embodiments as discussed above, the online social community sub-profiles may be generated for particular vendors and, if so, the generated sub-profile may be presented to the vendor in block 610 (i.e. without the need for the vendor to select the particular sub-profile).

After the selected online social community sub-profile has been displayed to the vendor in block 610 or if the vendor has not requested to view a different community profile (see block 604), the method 600 advances to block 612 in which the online social community profile server 102 determines whether the vendor has submitted a proposal. If not, the method 600 may loop back to block 602 in which the online social community profile may be displayed to another vendor. However, if the online social community profile server 102 has received a proposal from the vendor, the method 600 advances to block 614 in which the online social community profile server 102 determines whether the proposal is an active proposal. An active proposal may be embodied as any type of proposal involving the active or present participation of the online social community such as, for example, an online meeting, a live streaming event, or other live event in which the online social community is requested to participate. If the proposal is determined to be an active proposal, the method 600 advances to block 616 in which a date and time is established for the live proposal to be presented to the online social community. For example, the selected date/time may be voted on by the online social community or selected by the vendor. After the date and time for the live proposal ha been established in block 616, the method 600 advances to block 622 in which the online social community profile server 102 aggregates the proposal responses from the community as discussed below.

Referring back to block 614, if the online social community profile server 102 determines that the proposal is not an active proposal (e.g., the proposal is a coupon, an offer, poll, or other static proposal), the method 600 advances to block 618 in which the proposal is received from the vendor. The online social community profile server 102 may stored the received proposal in the data storage 128 and present the proposal to the online social community as a whole in block 620. The presentation of the proposal received from the vendor may be private to the online social community and, as such, may be accessible only by authenticated community members (e.g., the authenticated community members have entered a correct password).

Once the static or active proposal has been presented to the online social community, the community members may vote on, or otherwise respond to the proposal. For example, in embodiments in which the proposal is an offer, the community members may accept or reject the offer. Alternatively, in embodiments in which the proposal is a poll, the community members may answer (or not answer) the poll. As such, in block 622, the responses from each responding community member is received and aggregated by the social community profile server 102. The aggregated responses may be used to form an online social community profile response to the proposal.

In block 624, the online social community profile server 102 may notify the vendor of the online social community profile response. For example, the online social community profile server 102 may display the proposal results at the online location established or used by the online social community either publicly or privately (i.e., available only to the vendor) or may send the proposal results directly to the vendor computing device 150 or other computing device. Additionally, in some embodiments, the online social community profile response to the vendor's proposal may be presented to the online social community as a whole in block 624. Again, such presentation may be done publicly or privately with regard to the online social community.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

### EXAMPLES

Example 1 includes subject matter (such as a system, apparatus, a device, etc.) comprising a processor; and a memory having stored therein a plurality of instructions that when executed by the processor causes the online community profile server to: collect behavioral characteristics of a plurality of community members of an online social community; aggregate the behavioral characteristics of the plurality of community members; generate a social community profile as a function of the aggregated behavioral characteristics of the plurality of community member, allow access to the social community profile by a vendor, receive a proposal from a vendor in response to the social community profile; and determine a community response to the proposal received from the vendor.

In Example 2, the subject matter of Example 1 wherein to collect behavioral characteristics of the plurality of community members comprises to monitor an online behavior of the plurality of community members.

In Example 3, the subject matter of any of Examples 1 or 2 wherein to collect behavioral characteristics of the plurality of community members comprises to present an online questionnaire to community members further of the online social community and receive member responses to the online questionnaire from the community members.

In Example 4, the subject matter of any of Examples 1-3 wherein the online questionnaire comprises a plurality of behavioral characteristic questions, each behavioral characteristic question including an option to not answer the related behavior question.

In Example 5, the subject matter of any of Examples 1-4 wherein to present the online questionnaire comprises to present an option to the community members to not participate in the online questionnaire.

In Example 6, the subject matter of any of Examples 1-5 wherein the plurality of instructions further cause the online community profile server to securely store each community member's response in association with the respective community member.

In Example 7, the subject matter of any of Examples 1-6 wherein the plurality of instructions further cause the online community profile server to: present, to a sub-group of the online social community, a plurality of behavioral characteristics to track to generate the social community profile; and receive a selection of the plurality of behavioral characteristics from the sub-group of the online social community.

In Example 8, the subject matter of any of Examples 1-7 wherein the plurality of instructions further cause the online community profile server to: present the selected behavioral characteristics to track to generate the social community profile to the online social community; and receive voting responses from community members of the online social community for the selected behavioral characteristics.

In Example 9, the subject matter of any of Examples 1-8 wherein to receive member voting responses comprises to receive a voting response for each selected behavioral characteristic to track from each community member.

In Example 10, the subject matter of any of Examples 1-9 wherein the plurality of instructions further cause the online community profile server to generate the questionnaire as a function of the voting responses.

In Example 11, the subject matter of any of Examples 1-10 wherein to aggregate the behavioral characteristics of the plurality of community members comprises to average community member responses to an online questionnaire.

In Example 12, the subject matter of any of Examples 1-11 wherein to aggregate the behavioral characteristics of the plurality of community members comprises to update a previously-generated social community profile as a function of the aggregated behavioral characteristics of the plurality of community members.

In Example 13, the subject matter of any of Examples 1-12 wherein to allow access to the social community profile comprises to present the social community profile at an online location associated with the online social community.

In Example 14, the subject matter of any of Examples 1-13 wherein to receive the proposal from the vendor comprises to receive an online request from the vendor for an online meeting with community members of the online social community.

In Example 15, the subject matter of any of Examples 1-14 wherein the proposal comprises at least one of an advertisement, an offer, a request for support of the online social community, and a marketing poll.

In Example 16, the subject matter of any of Examples 1-15 wherein the plurality of instructions further cause the online community profile server to generate a charge to the vendor for access to the social community profile.

In Example 17, the subject matter of any of Examples 1-16 wherein the vendor comprises at least one of a business, a charitable organization, an another online social community, a political organization, and marketing research company.

In Example 18, the subject matter of any of Examples 1-17 wherein the plurality of instructions further cause the online community profile server to: receive a request for a different social community profile of the online social community from the vendor, present available social community sub-profiles to the vendor, receive a section of one of the available social community sub-profiles; retrieve the social community sub-profile from data storage; and present the selected social community sub-profile to the vendor.

In Example 19, the subject matter of any of Examples 1-18 wherein the plurality of instructions further cause the online community profile server to: present the proposal to the online social community for vote; receive voting response to the proposal from community members of the online social community; and aggregate the voting responses to the proposal received form the community members to generate a social community response to the proposal.

In Example 20, the subject matter of any of Examples 1-19 wherein the plurality of instructions further cause the online community profile server to notifying the vendor of the social community response.

In Example 21, the subject matter of any of Examples 1-20 wherein the plurality of instructions further cause the online community profile server to presenting the social community response to the online social community.

In Example 22, the subject matter of any of Examples 1-21 wherein the plurality of instructions further cause the online community profile server to predict at least one of a future product need and a future service need for the online social community as a function of the behavioral characteristics of the plurality of community members, wherein the social community profile includes at least one predicted future product need and future service need.

Example 23 includes subject matter (such as a system, apparatus, a device, etc.) comprising collecting, on a computing device, behavioral characteristics of a plurality of community members of an online social community; aggregating, on the computing device, the behavioral characteristics of the plurality of community members; generating a social community profile as a function of the aggregated behavioral characteristics of the plurality of community member, allowing online access to the social community profile; and receiving, on the computing device, a proposal from a vendor in response to the social community profile.

In Example 24, the subject matter of Example 23 wherein collecting behavioral characteristics of the plurality of community members comprises presenting an online questionnaire to community members of the online social community and receiving member responses to the online questionnaire from the community members.

In Example 25, the subject matter of any of Examples 23 or 24 wherein presenting the online questionnaire comprises presenting an online questionnaire further comprising a plurality of behavioral characteristic questions, each behavioral characteristic question including an option to not answer the related behavior question.

In Example 26, the subject matter of any of Examples 23-25 wherein presenting the online questionnaire comprises presenting an option to the community members to not participate in the online questionnaire.

In Example 27, the subject matter of any of Examples 23-26 wherein further comprises securely storing each community member's response in association with the respective community member.

In Example 28, the subject matter of any of Examples 23-27 wherein presenting, to a sub-group of the online social community, a plurality of behavioral characteristics to track to generate the social community profile; and receiving a selection of the plurality of behavioral characteristics from the sub-group of the online social community.

In Example 29, the subject matter of any of Examples 23-28 wherein presenting the selected behavioral characteristics to track to generate the social community profile to the online social community; and receiving voting responses from community members of the online social community for the selected behavioral characteristics.

In Example 30, the subject matter of any of Examples 23-29 wherein receiving member voting responses comprises receiving a voting response for each selected behavioral characteristic to track from each community member.

In Example 31, the subject matter of any of Examples 23-30 wherein further comprising generating the questionnaire as a function of the voting responses.

In Example 32, the subject matter of any of Examples 23-31 wherein collecting behavioral characteristics of the plurality of community members comprises monitoring an online behavior of the plurality of community members.

In Example 33, the subject matter of any of Examples 23-32 wherein aggregating the behavioral characteristics of the plurality of community members comprises averaging community member responses to an online questionnaire.

In Example 34, the subject matter of any of Examples 23-33 wherein aggregating the behavioral characteristics of the plurality of community members comprises updating a previously-generated social community profile as a function of the aggregated behavioral characteristics of the plurality of community members.

In Example 35, the subject matter of any of Examples 23-34 wherein allowing online access to the social community profile comprises presenting the social community profile at an online location associated with the online social community.

In Example 36, the subject matter of any of Examples 23-35 wherein receiving the proposal from the vendor comprises receiving an online request from the vendor for an online meeting with community members of the online social community.

In Example 37, the subject matter of any of Examples 23-36 wherein receiving the proposal comprises receiving at least one of an advertisement, an offer, a request for support of the online social community, and a marketing poll.

In Example 38, the subject matter of any of Examples 23-37 wherein further comprising generating a charge to the vendor for access to the social community profile.

In Example 39, the subject matter of any of Examples 23-38 wherein receiving the proposal from the vendor comprises receiving a proposal from one of a business, a charitable organization, an another online social community, a political organization, and marketing research company.

In Example 40, the subject matter of any of Examples 23-39 wherein receiving a request for a different social community profile of the online social community from the vendor, presenting available social community sub-profiles to the vendor, receiving a section of one of the available social community sub-profiles; retrieving the social community sub-profile from data storage; and presenting the selected social community sub-profile to the vendor.

In Example 41, the subject matter of any of Examples 23-40 wherein presenting the proposal to the online social community for vote; receiving voting response to the proposal from community members of the online social community; and aggregating the voting responses to the proposal received form the community members to generate a social community response to the proposal.

In Example 42, the subject matter of any of Examples 23-41 wherein further comprising notifying the vendor of the social community response.

In Example 43, the subject matter of any of Examples 23-42 wherein further comprising presenting the social community response to the online social community.

In Example 44, the subject matter of any of Examples 23-43 wherein further comprising predicting at least one of a future product need and a future server need for the online social community as a function of the behavioral characteristics of the plurality of community members.

Example 45 includes subject matter (such as a system, apparatus, a device, etc.) comprising a processor, and a memory having stored therein a plurality of instructions that, in response to being executed by the processor, results in the processor performing the method of any of claims 23-44.

Example 46 includes subject matter (such as a system, apparatus, a device, etc.) comprising One or more machine readable media comprising a plurality of instructions stored thereon that in response to being executed result in a computing device performing any of claims 23-44.

Example 47 includes subject matter (such as a system, apparatus, a device, etc.) comprising a processor coupled to a memory; a behavioral characteristic logic unit communicatively coupled to the processor to collect behavioral characteristics of a plurality of community members of an online social community; and an online social community profile logic unit communicatively coupled to the processor to aggregate the behavioral characteristics of the plurality of community members, and to generate a social community profile as a function of the aggregated behavioral characteristics of the plurality of community members.

In Example 48, the subject matter of Example 47 wherein further comprising a vendor presentation logic unit communicatively coupled to the processor to allow access to the social community profile by a vendor and to receive a proposal from a vendor in response to the social community profile.

In Example 49, the subject matter of any of Examples 47 or 48 wherein the vendor presentation logic further to determine a community response to the proposal received from the vendor.

In Example 50, the subject matter of any of Examples 47-49 wherein the behavioral characteristic logic unit to monitor an online behavior of the plurality of community members.

In Example 51, the subject matter of any of Examples 47-50 wherein to collect behavioral characteristics of the plurality of community members comprises to present an online questionnaire to community members further of the online social community and receive member responses to the online questionnaire from the community members.

In Example 52, the subject matter of any of Examples 47-51 wherein the online questionnaire comprises a plurality of behavioral characteristic questions, each behavioral characteristic question including an option to not answer the related behavior question.

In Example 53, the subject matter of any of Examples 47-52 wherein to present the online questionnaire comprises to present an option to the community members to not participate in the online questionnaire.

In Example 54, the subject matter of any of Examples 47-53 wherein the behavioral characteristic logic unit further to securely store each community member's response in association with the respective community member.

In Example 55, the subject matter of any of Examples 47-54 wherein the behavioral characteristic logic unit further to: present, to a sub-group of the online social community, a plurality of behavioral characteristics to track to generate the social community profile; and receive a selection of the plurality of behavioral characteristics from the sub-group of the online social community.

In Example 56, the subject matter of any of Examples 47-55 wherein the behavioral characteristic logic unit further to: present the selected behavioral characteristics to track to generate the social community profile to the online social community; and receive voting responses from community members of the online social community for the selected behavioral characteristics.

In Example 57, the subject matter of any of Examples 47-56 wherein to receive member voting responses comprises to receive a voting response for each selected behavioral characteristic to track from each community member.

In Example 58, the subject matter of any of Examples 47-57 wherein the behavioral characteristic logic unit further to generate the questionnaire as a function of the voting responses.

In Example 59, the subject matter of any of Examples 47-58 wherein to aggregate the behavioral characteristics of the plurality of community members comprises to average community member responses to an online questionnaire.

In Example 60, the subject matter of any of Examples 47-59 wherein to aggregate the behavioral characteristics of the plurality of community members comprises to update a previously-generated social community profile as a function of the aggregated behavioral characteristics of the plurality of community members.

In Example 61, the subject matter of any of Examples 47-60 wherein to allow access to the social community profile comprises to present the social community profile at an online location associated with the online social community.

In Example 62, the subject matter of any of Examples 47-61 wherein to receive the proposal from the vendor comprises to receive an online request from the vendor for an online meeting with community members of the online social community.

In Example 63, the subject matter of any of Examples 47-62 wherein the proposal comprises at least one of an advertisement, an offer, a request for support of the online social community, and a marketing poll.

In Example 64, the subject matter of any of Examples 47-63 wherein the vendor presentation logic unit further to generate a charge to the vendor for access to the social community profile.

In Example 65, the subject matter of any of Examples 47-64 wherein the vendor comprises at least one of a business, a charitable organization, an another online social community, a political organization, and marketing research company.

In Example 66, the subject matter of any of Examples 47-65 wherein receive a request for a different social community profile of the online social community from the vendor, present available social community sub-profiles to the vendor; receive a section of one of the available social community sub-profiles; retrieve the social community sub-profile from data storage; and present the selected social community sub-profile to the vendor.

In Example 67, the subject matter of any of Examples 47-66 wherein present the proposal to the online social community for vote; receive voting response to the proposal from community members of the online social community; and aggregate the voting responses to the proposal received form the community members to generate a social community response to the proposal.

In Example 68, the subject matter of any of Examples 47-67 wherein the behavioral characteristic logic unit further to predict at least one of a future product need and a future service need for the online social community as a function of the behavioral characteristics of the plurality of community members, wherein the social community profile includes at least one predicted future product need and future service need.

1-68. (canceled)

69. An online community profile server comprising:
a behavioral characteristic logic unit communicatively to collect behavioral characteristics of a plurality of community members of an online social community;
an online social community profile logic unit to (i) aggregate the behavioral characteristics of the plurality of community members and (ii) generate a social community profile as a function of the aggregated behavioral characteristics of the plurality of community members; and
a vendor presentation logic unit to (i) allow access to the social community profile by a vendor, (ii) receive a proposal from a vendor in response to the social community profile, and (iii) determine a community response to the proposal received from the vendor.

70. The online community profile server of claim 69, wherein the behavioral characteristic logic unit to monitor an online behavior of the plurality of community members.

71. The online community profile server of claim 69, wherein to collect behavioral characteristics of the plurality of community members comprises to present an online questionnaire to community members of the online social community and receive member response to the online questionnaire from the community members.

72. The online community profile server of claim 71, wherein the online questionnaire comprises a plurality of behavioral characteristic questions, each behavioral characteristic question including an option to not answer the related behavior question.

73. The online community profile server of claim 71, wherein to present the online questionnaire comprises to present an option to the community members to not participate in the online questionnaire.

74. The online community profile server of claim 71, wherein the behavioral characteristic logic unit further to:
present, to a sub-group of the online social community, a plurality of behavioral characteristics to track to generate the social community profile; and
receive a selection of the plurality of behavioral characteristics from the sub-group of the online social community.

75. The online community profile server of claim 71, wherein the behavioral characteristic logic unit further to:
present the selected behavioral characteristics to track to generate the social community profile to the online social community;
receive voting responses from community members of the online social community for the selected behavioral characteristics; and
generate the questionnaire as a function of the voting responses.

76. The online community profile server of claim 69, wherein to allow access to the social community profile comprises to present the social community profile at an online location associated with the online social community.

77. The online community profile server of claim 69, to receive the proposal from the vendor comprises to receive an online request from the vendor for an online meeting with community members of the online social community.

78. The online community profile server of claim 69, wherein the vendor presentation logic unit further to generate a charge to the vendor for access to the social community profile.

79. The online community profile server of claim 69 the vendor presentation logic unit further to:
receive a request for a different social community profile of the online social community from the vendor,
present available social community sub-profiles to the vendor,
receive a section of one of the available social community sub-profiles;
retrieve the social community sub-profile from data storage; and
present the selected social community sub-profile to the vendor.

80. One or more machine readable media comprising a plurality of instructions that, in response to being executed, cause a computing device to:
collect behavioral characteristics of a plurality of community members of an online social community;
aggregate the behavioral characteristics of the plurality of community members;
generate a social community profile as a function of the aggregated behavioral characteristics of the plurality of community member;
allow online access to the social community profile; and
receive a proposal from a vendor in response to the social community profile.

81. The one or more machine readable media of claim 80, wherein to collect behavioral characteristics of the plurality of community members comprises to present an online questionnaire to community members of the online social community and receive member responses to the online questionnaire from the community members.

82. The one or more machine readable media of claim 81, wherein to present the online questionnaire comprises to present an online questionnaire comprising a plurality of behavioral characteristic questions, each behavioral characteristic question including an option to not answer the related behavior question.

83. The one or more machine readable media of claim 81, wherein the plurality of instructions further cause the computing device to:
present, to a sub-group of the online social community, a plurality of behavioral characteristics to track to generate the social community profile; and
receive a selection of the plurality of behavioral characteristics from the sub-group of the online social community.

84. The one or more machine readable media of claim 83, wherein the plurality of instructions further cause the computing device to:
present the selected behavioral characteristics to track to generate the social community profile to the online social community;
receive voting responses from community members of the online social community for the selected behavioral characteristics; and
generate the questionnaire as a function of the voting responses.

85. The one or more machine readable media of claim 80, wherein to collect behavioral characteristics of the plurality of community members comprises to monitor an online behavior of the plurality of community members.

86. The one or more machine readable media of claim 80, wherein to allow online access to the social community profile comprises to present the social community profile at an online location associated with the online social community.

87. The one or more machine readable media of claim 80, wherein to receive the proposal from the vendor comprises to receive an online request from the vendor for an online meeting with community members of the online social community.

88. The one or more machine readable media of claim 80, wherein the plurality of instructions further cause the computing device to generate a charge to the vendor for access to the social community profile.

89. The one or more machine readable media of claim 80, wherein the plurality of instructions further cause the computing device to:
receive a request for a different social community profile of the online social community from the vendor,
present available social community sub-profiles to the vendor,
receive a section of one of the available social community sub-profiles;
retrieve the social community sub-profile from data storage; and
present the selected social community sub-profile to the vendor.

90. The one or more machine readable media of claim 80, wherein the plurality of instructions further cause the computing device to:
present the proposal to the online social community for vote;
receive voting response to the proposal from community members of the online social community; and
aggregate the voting responses to the proposal received form the community members to generate a social community response to the proposal.

91. A method comprising:
collecting, on a computing device, behavioral characteristics of a plurality of community members of an online social community;
aggregating, on the computing device, the behavioral characteristics of the plurality of community members;
generating a social community profile as a function of the aggregated behavioral characteristics of the plurality of community member;
allowing online access to the social community profile; and
receiving, on the computing device, a proposal from a vendor in response to the social community profile.

92. The method of claim 91, wherein collecting behavioral characteristics of the plurality of community members comprises presenting an online questionnaire to community members of the online social community and receiving member responses to the online questionnaire from the community members.

93. The method of claim 91, further comprising:
presenting the proposal to the online social community for vote;
receiving voting response to the proposal from community members of the online social community; and
aggregating the voting responses to the proposal received from the community members to generate a social community response to the proposal.
